(19) United States
(12) Patent Application Publication
(10) Pub. No.: US 2014/0119155 A1
(43) Pub. Date: May 1, 2014

(54) HYDRODYNAMIC SUPER-CAVITATION APPARATUS

(71) Applicants: Baek-Geum Kim, Seoul (KR); Stuart Sung Han, Surrey (CA)

(72) Inventors: Baek-Geum Kim, Seoul (KR); Stuart Sung Han, Surrey (CA)

(73) Assignee: KOREA CAVITATION CO., LTD., Seoul (KR)

(21) Appl. No.: 14/126,044

(22) PCT Filed: Jun. 15, 2012
(86) PCT No.: PCT/KR2012/004714

§ 371 Date: Dec. 13, 2013

(30) Foreign Application Priority Data
Jun. 15, 2011 (KR) 10-2011-0057871

(51) Int. Cl. B01F 5/06

(52) U.S. Cl. CPC B01F 5/06
USPC 366/176.1

(57) ABSTRACT

A hydrodynamic supercavitation apparatus includes: a body having one side connected to a fluid supply line for supplying fluid and a section decreasing space portion whose cross sectional area is gradually decreased formed at the inside thereof, the section decreasing space portion having a large space portion formed on one side thereof in such a manner as to communicate with the fluid supply line and a small space portion formed on the other side thereof; an outlet cap coupled to one end of the body and having a first section increasing space portion formed on one side of the interior thereof in such a manner as to communicate with the small space portion of the body and a second section increasing space portion formed on the other side of the interior thereof in such a manner as to be gradually increased from a smaller cross sectional area than the first section increasing space portion toward a larger cross sectional area than the first section increasing space portion; a closing cap coupled to the other end of the body so as to close the other end of the body; and a center bar supportedly coupled to the closing cap on one end thereof and passed through the interior of the body in such a manner as to be extended to the second section increasing space portion of the outlet cap.

### BACKGROUND

The present invention relates to a hydrodynamic supercavitation apparatus, and more particularly, to a hydrodynamic supercavitation apparatus that makes use of the action force generated from the production, expansion and collapse of steam bubble cavitation through the pressure difference between the front and rear sides of a Venturi portion whose cross sectional area is increased after decreased if a fluid flows into a pipe where the Venturi portion is formed, thus conducting biodiesel production, emulsification, water treatment, descaling, particle crushing, and the like.

1. Background Art

Generally, in case where a fluid flows into a pipe having a Venturi portion whose cross sectional area is increased after decreased, the speed of the flowing fluid becomes reduced in a portion where the cross sectional area of the pipe is decreased, thus increasing the pressure of the fluid, and contrarily, the speed of the flowing fluid becomes increased in a portion where the cross sectional area of the pipe is increased, thus lowering the pressure of the fluid. At this time, cavitation with numerous steam bubbles is produced, expanded and then collapsed through the pressure difference between the section decreasing portion and the section increasing portion of the pipe.

Specifically, the steam bubbles collide against each other on the outlet side of the pipe wherein the cavitation collapses, thus generating shock waves thereon. Accordingly, substantially high pressure and heat are generated, and further, free hydroxyl radicals are formed.

As mentioned above, generally, a hydrodynamic supercavitation apparatus is configured wherein the action force generated from the production, expansion and collapse of steam bubble cavitation is obtained through a fluid flowing at a high pressure into a pipe having a Venturi portion whose cross sectional area is increased after decreased, thus conducting biodiesel production, emulsification for emulsion oil, cosmetic and mayonnaise, water treatment, descaling of cooling tower, particle crushing, and the like.

2. Disclosure

However, conventional hydrodynamic supercavitation apparatuses make use of only the production, expansion and collapse of steam bubble cavitation, so that the action force of the outlet side on which the steam bubble cavitation actually collapses is unfortunately weak to decrease the effects of biodiesel production, emulsification, water treatment, descaling, particle crushing, and the like.

### SUMMARY OF THE INVENTION

Accordingly, the present invention has been made in view of the above-mentioned problems occurring in the prior art, and it is an object of the present invention to provide a hydrodynamic supercavitation apparatus that is capable of substantially increasing the action force of an outlet side on which steam bubble cavitation collapses, so that effects of biodiesel production, emulsification, water treatment, descaling, particle crushing, and the like can be doubled.

### Technical Solution

To accomplish the above-mentioned object, according to the present invention, there is provided a hydrodynamic supercavitation apparatus includes: a body having one side connected to a fluid supply line for supplying fluid and a section decreasing space portion whose cross sectional area is gradually decreased formed at the inside thereof, the section decreasing space portion having a large space portion formed on one side thereof in such a manner as to communicate with the fluid supply line and a small space portion formed on the other side thereof; an outlet cap coupled to one end of the body and having a first section increasing space portion formed on one side of the interior thereof in such a manner as to communicate with the small space portion of the body and a second section increasing space portion formed on the other side of the interior thereof in such a manner as to be gradually increased from a smaller cross sectional area than the first section increasing space portion toward a larger cross sectional area than the first section increasing space portion; a closing cap coupled to the other end of the body so as to close the other end of the body; and a center bar supportedly coupled to the closing cap on one end thereof and passed through the interior of the body in such a manner as to be extended to the second section increasing space portion of the outlet cap.

According to the present invention, preferably, the fluid supply line is connected to an external fluid supply source, and a high pressure pump is mounted on the fluid supply line, for forcedly supplying the fluid to the interior of the body from the external fluid supply source.

According to the present invention, preferably, the body and the outlet cap are formed integrally to each other.

According to the present invention, preferably, the closing cap includes: an insert guide whose one side periphery is pressed-fitted to the other end of the body and having a coupling groove formed on the other side periphery thereof; a center bar supporter coupled to the coupling groove of the insert guide; a first screw cap screw-coupled to the other end of the body and pressurizingly contacting the insert guide and the center bar supporter with the body; and a second screw cap screw-coupled to the center bar supporter.

According to the present invention, the hydrodynamic supercavitation apparatus is configured to provide the large space portion communicating with the fluid supply line, the section decreasing space portion and the large space portion sequentially formed in the interior of the body and further provide the first section increasing space portion communicating with the small space portion and the second section increasing space portion gradually increased from a smaller cross sectional area than the first section increasing space portion toward a larger cross sectional area than the first section increasing space portion sequentially formed in the interior of the outlet cap, so that the cavitation is not simply produced, expanded and collapsed, but the cavitation generated by the flow of the fluid through the section decreasing space portion is primarily expanded in the first section increasing space portion, contracted just before introduced into the second section increasing space portion, and secondarily expanded and finally collapsed in the second section increasing space portion, thus substantially increasing the action force on the outlet side of the outlet cap to allow the effects of biodiesel production, emulsification, water treatment, descaling, particle crushing and the like to be doubled.

Additionally, the hydrodynamic supercavitation apparatus is configured to provide the center bar passed through the large space portion, the section decreasing space portion and the large space portion of the body, and the first section increasing space portion of the outlet cap, sequentially, and then extended to the second section increasing space portion of the outlet cap, so that the friction contact area with the fluid can be doubled to increase amounts of cavitation production and collapse to allow the effects of biodiesel production, emulsification, water treatment, descaling, particle crushing and the like to be doubled.

### BRIEF DESCRIPTION OF DRAWINGS

FIG. 1 is a schematic diagram showing the use state of a hydrodynamic supercavitation apparatus according to the present invention.

FIG. 2 is a sectional view showing the hydrodynamic supercavitation apparatus according to the present invention.

FIG. 3 is a sectional view showing the operation of the hydrodynamic supercavitation apparatus according to the present invention.

### DETAILED DESCRIPTION OF THE INVENTION

Hereinafter, an explanation on a hydrodynamic supercavitation apparatus according to the present invention will be in detail given with reference to the attached drawings. It is to be appreciated that those skilled in the art can change or modify the embodiments without departing from the scope and spirit of the present invention.

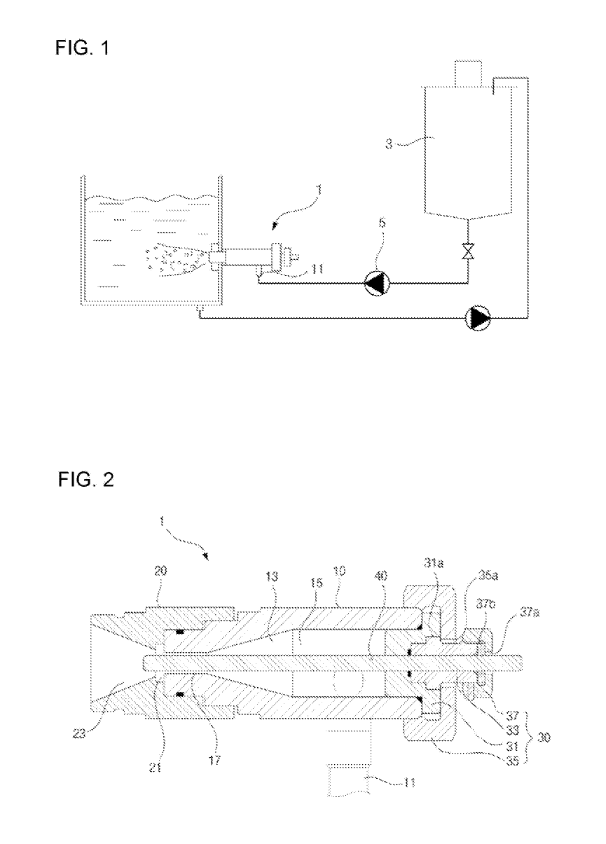

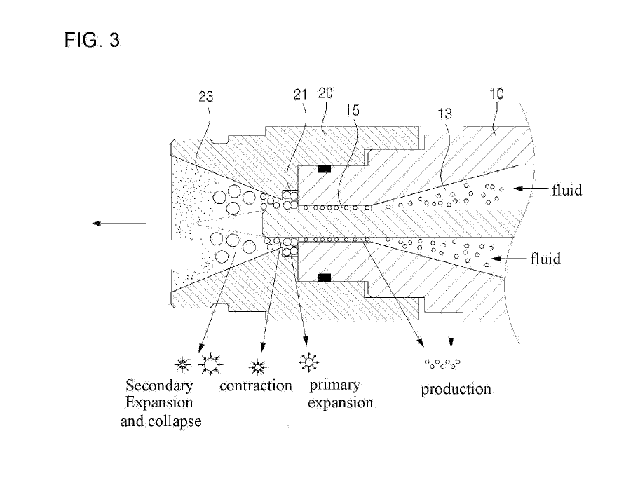

According to the present invention, a hydrodynamic supercavitation apparatus 1 makes use of the action force generated from the production, expansion and collapse of the steam bubble cavitation through the pressure difference between the front and rear sides of a Venturi portion whose cross sectional area is increased after decreased if a fluid flows into a pipe where the Venturi portion is formed, thus conducting biodiesel production, emulsification, water treatment, descaling, particle crushing, and the like. As shown in FIGS. 1 to 3, the hydrodynamic supercavitation apparatus according to the present invention includes a body 10 having one side connected to a fluid supply line 11 for supplying fluid and a section decreasing space portion 13 whose cross-section is gradually decreased formed at the inside thereof, the section decreasing space portion 13 having a large space portion 15 formed on one side thereof in such a manner as to communicate with the fluid supply line 11 and a small space portion 17 formed on the other side thereof; an outlet cap 20 coupled to one end of the body 10 and having a first section increasing space portion 21 formed on one side of the interior thereof in such a manner as to communicate with the small space portion 17 of the body 10 and a second section increasing space portion 23 formed on the other side of the interior thereof in such a manner as to be gradually increased from a smaller cross sectional area than the first section increasing space portion 21 toward a larger cross sectional area than the first section increasing space portion 21; a closing cap 30 coupled to the other end of the body 10 so as to close the other end of the body 10; and a center bar 40 supportedly coupled to the closing cap 30 on one end thereof and passed through the interior of the body 10 in such a manner as to be extended to the second section increasing space portion 23 of the outlet cap 20.

In this case, the body 10 constitutes the casing of the hydrodynamic supercavitation apparatus according to the present invention, and the body 10 has one side connected to the fluid supply line 11 for supplying fluid and the section decreasing space portion 13 whose cross sectional area is gradually decreased formed at the inside thereof. The section decreasing space portion 13 has the large space portion 15 formed on one side thereof in such a manner as to communicate with the fluid supply line 11 and the small space portion 17 formed on the other side thereof.

As shown in FIG. 1, the fluid supply line 11 forcibly supplies the fluid to the interior of the body 10 from an external fluid supply source 3, and the external fluid supply source 3 and the body 10 are connected to each other. Further, a high pressure pump is mounted on the fluid supply line 11, for forcedly supplying the fluid to the interior of the body 10 from the external fluid supply source 3.

The section decreasing space portion 13 is gradually decreased in the cross sectional area thereof in the advancing direction of the fluid, thus reducing the speed of the fluid and at the same time increasing the pressure of the fluid, so that a pressure difference occurs through the section decreasing space portion 13 to generate steam bubble cavitation through internal friction.

The large space portion 15 formed on one side of the section decreasing space portion 13 communicates with the fluid supply line 11 and serves to supply the fluid to the section decreasing space portion 13. On the other hand, the small space portion 17 formed on the other side of the section decreasing space portion 13 serves to maintain the speed reduction state of the fluid and the pressure increase state of the fluid formed by the section decreasing space portion 13 until the fluid reaches the first section increasing space portion 21 of the outlet cap 20.

The outlet cap 20 is, for example, screw-coupled to one end of the body 10, and the outlet cap 20 forms the outlet portion from which the fluid having optimized action force is discharged through the collapse of the cavitation. The outlet cap 20 has the first section increasing space portion 21 formed on one side of the interior thereof in such a manner as to communicate with the small space portion 17 of the body 10 and the second section increasing space portion 23 formed on the other side of the interior thereof in such a manner as to be gradually increased from a smaller cross sectional area than the first section increasing space portion 21 toward a larger cross sectional area than the first section increasing space portion 21.

Desirably, the section decreasing space portion 13 of the body 10 is conically shaped and the large and small space portions 15 and 17 of the body 10 are cylindrically shaped.

The first section increasing space portion 21 serves to primarily drastically expand the cavitation generated through the flowing of the section decreasing space portion 13 of the body 10, and therefore, the first section increasing space portion 21 has a shape of a cylinder having a larger diameter than the small space portion 17 of the body 10, thus drastically increasing the speed of the fluid and at the same time drastically decreasing the pressure of the fluid, so that the cavitation can be primarily drastically expanded.

The second section increasing space portion 23 serves to secondarily expand the cavitation contracted again at the connection point thereof with the first section increasing space portion 21 after the cavitation has been drastically expanded by means of the first section increasing space portion 21 and to allow the secondarily expanded cavitation to finally collapse. The second section increasing space portion 23 has a shape of a cone gradually increased from a smaller cross sectional area than the first section increasing space portion 21 toward a larger cross sectional area than the first section increasing space portion 21.

Accordingly, the cavitation, which is generated from the fluid introduced into the large space portion 15 of the body 10 through the fluid supply line 11 and flowing through the section decreasing space portion 13 of the body 10, is primarily expanded drastically through the flow rate increase and the pressure reduction in the first section increasing space portion 21. After that, the cavitation is contracted through the flow rate reduction and the pressure increase according to the decrease of the cross sectional area of the connection point between the first section increasing space portion 21 and the second section increasing space portion 23, and secondarily expanded and collapsed through the flow rate increase and the pressure reduction in the second section increasing space portion 23, thus generating high pressure and heat from the outlet side of the outlet cap 20.

The body 10 and the outlet cap 20 are separately manufactured from each other in such a manner as to be coupled to each other, and otherwise, they may be formed integrally to each other.

The closing cap 30 is coupled to the other end of the body 10 so as to close the other end of the body 10 and at the same time to support the center bar 40 as will be discussed later thereagainst. The closing cap 30 includes: an insert guide 31 whose one side periphery is pressed-fitted to the other end of the body 10 and having a coupling groove 31a formed on the other side periphery thereof; a center bar supporter 33 coupled to the coupling groove 31a of the insert guide 31; a first screw cap 35 screw-coupled to the other end of the body 10 and pressurizingly contacting the insert guide 31 and the center bar supporter 33 with the body 10; and a second screw cap 37 screw-coupled to the center bar supporter 33.

Further, the first screw cap 35 of the closing cap 30 has a first through-hole 35a formed thereon, through which a portion of the center bar supporter 33 is protruded outwardly from the first screw cap 35, so that the second screw cap 37 is coupled to the end periphery of the center bar supporter 33 protruded from the first screw cap 35. On the other hand, the second screw cap 37 of the closing cap 30 has a second through-hole 37a formed thereon, through which a portion of the center bar 40 is protruded outwardly from the second screw cap 37, and a washer 37b is inserted into the inside of the second screw cap 37.

Further, the center bar 40 is supportedly coupled to the closing cap 30 against one end periphery thereof, and the center bar 40 increases the friction contact area with the fluid, which increases amounts of cavitation production and collapse. The center bar 40 is passed through the interior of the body 10 in such a manner as to be extended to the second section increasing space portion 23 of the outlet cap 20. In more detail, the center bar 40 is passed through the large space portion 15, the section decreasing space portion 13 and the large space portion 17 of the body 10, and the first section increasing space portion 21 of the outlet cap 20, sequentially, and then extended to the second section increasing space portion 23 of the outlet cap 20.

According to the present invention, therefore, the hydrodynamic supercavitation apparatus 1 is configured to provide the large space portion 15 communicating with the fluid supply line 11, the section decreasing space portion 13 and the large space portion 17 sequentially formed in the interior of the body 10 and further provide the first section increasing space portion 21 communicating with the small space portion 17 and the second section increasing space portion 23 gradually increased from a smaller cross sectional area than the first section increasing space portion 21 toward a larger cross sectional area than the first section increasing space portion 21 sequentially formed in the interior of the outlet cap 20, so that the cavitation is not simply produced, expanded and collapsed, but the cavitation generated by the flow of the fluid through the section decreasing space portion 13 is primarily expanded in the first section increasing space portion 21, contracted just before introduced into the second section increasing space portion 23, and secondarily expanded and finally collapsed in the second section increasing space portion 23, thus substantially increasing the action force on the outlet side of the outlet cap 20 to allow the effects of biodiesel production, emulsification, water treatment, descaling, particle crushing and the like to be doubled.

According to the present invention, therefore, the hydrodynamic supercavitation apparatus 1 is configured to provide the center bar 40 passed through the large space portion 15, the section decreasing space portion 13 and the large space portion 17 of the body 10, and the first section increasing space portion 21 of the outlet cap 20, sequentially, and then extended to the second section increasing space portion 23 of the outlet cap 20, so that the friction contact area with the fluid can be doubled to increase amounts of cavitation production and collapse to allow the effects of biodiesel production, emulsification, water treatment, descaling, particle crushing and the like to be doubled.

### INDUSTRIAL APPLICABILITY

According to the present invention, the hydrodynamic supercavitation apparatus is applicable to various fields, such as biodiesel production, emulsification, water treatment, descaling, particle crushing and the like.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A hydrodynamic supercavitation apparatus comprising:
a body having one side connected to a fluid supply line for supplying fluid and a section decreasing space portion whose cross sectional area is gradually decreased formed at the inside thereof, the section decreasing space portion having a large space portion formed on one side thereof in such a manner as to communicate with the fluid supply line and a small space portion formed on the other side thereof;
an outlet cap coupled to one end of the body and having a first section increasing space portion formed on one side of the interior thereof in such a manner as to communicate with the small space portion of the body and a second section increasing space portion formed on the other side of the interior thereof in such a manner as to be gradually increased from a smaller cross sectional area than the first section increasing space portion toward a larger cross sectional area than the first section increasing space portion;
a closing cap coupled to the other end of the body so as to close the other end of the body; and
a center bar supportedly coupled to the closing cap on one end thereof and passed through the interior of the body in such a manner as to be extended to the second section increasing space portion of the outlet cap.

2. The hydrodynamic supercavitation apparatus according to claim 1, wherein the fluid supply line is connected to an external fluid supply source, and a high pressure pump is mounted on the fluid supply line, for forcedly supplying the fluid to the interior of the body from the external fluid supply source.

3. The hydrodynamic supercavitation apparatus according to claim 1, wherein the body and the outlet cap are formed integrally to each other.

4. The hydrodynamic supercavitation apparatus according to claim 1, wherein the closing cap comprises:
an insert guide whose one side periphery is pressed-fitted to the other end of the body and having a coupling groove formed on the other side periphery thereof;
a center bar supporter coupled to the coupling groove of the insert guide;
a first screw cap screw-coupled to the other end of the body and pressurizingly contacting the insert guide and the center bar supporter with the body; and
a second screw cap screw-coupled to the center bar supporter.
